(19) United States
(12) Patent Application Publication
(10) Pub. No.: US 2012/0147401 A1
(43) Pub. Date: Jun. 14, 2012

(54) MULTI-FUNCTION IMAGE FORMING APPARATUS

(75) Inventors: Chai Song Poh, Sunset Way (SG); Tsui Tai Leung, Singapore (SG); Vivek Chopra, Singapore (SG)

(73) Assignee: DELL PRODUCTS L.P., Round Rock, TX (US)

(21) Appl. No.: 12/965,540

(22) Filed: Dec. 10, 2010

(51) Int. Cl. G06F 3/12

(52) U.S. Cl. 358/1.13

(57) ABSTRACT

A method of recording workflows for a multi-function image forming apparatus such as a multi-function printer including receiving a selection of an operation. The operation is at least one of a printing, a faxing, a scanning, and a copying operation performed by a multi-function image forming apparatus. The method further includes receiving a selection of a first preference associated with the first operation. A workflow is generated and stored which includes the first operation and the first preference. The workflow is subsequently used to perform the selected operation (with first preference) on a document positioned on an input feeder of the multi-function image forming apparatus. A computer-readable medium and multi-function image forming apparatus having recordable workflows are also described.

### BACKGROUND

The present disclosure relates generally to multi-function image forming apparatus and more particularly to an apparatus having a recordable workflow functionality.

As the value and use of information continues to increase, individuals and businesses seek additional ways to process documentation. One option is to use a multi-function image forming apparatus or multi-function printer. A multi-function image forming apparatus generally receives, scans, prints, copies, faxes, stores and/or otherwise communicates information or data for business, personal, or other purposes. For example, a multi-function image forming apparatus may receive a document (e.g., paper) with one or more pieces of data printed thereon, store the data and transfer or communicate the data to one or more different locations. For example, the multi-function image forming apparatus may form (e.g., reproduce) the data on another document (e.g., paper) in the multi-function image forming apparatus, a file, an email, a fax, a file including the data may be sent a remote server location, and/or other typical locations.

A typical multi-function image forming apparatus or multi-function printer is equipped with standard processes that users perform on a regular basis, which may be selected from a menu. These standard processes however do not address unique requirements that may be present in the user's environment. These unique requirements may include repetitive and time consuming processes (e.g., business processes) or operations.

Accordingly, it would be desirable to provide an improved multi-function image forming apparatus and method of use thereof.

### SUMMARY

According to one embodiment, a method is described which includes receiving a selection of an operation. The operation is at least one of a printing, a faxing, a scanning, and a copying operation performed by a multi-function image forming apparatus. The method further includes receiving a selection of a first preference associated with the first operation. A workflow is generated which includes the first operation and the first preference. The generated workflow is stored in the multi-function image forming apparatus. The stored workflow is subsequently used to perform the selected operation (with first preference) on a document input into the multi-function image forming apparatus.

### BRIEF DESCRIPTION OF THE DRAWINGS

FIGS. 1a and 1b are flow charts illustrative of an embodiment of a method according to aspects of the present disclosure.

FIG. 2 is a perspective view of an embodiment of a multi-function image forming apparatus.

FIG. 3 is a block diagram of an embodiment of a multi-function image forming apparatus.

FIG. 4 is a block diagram of an embodiment of an embedded software stack that may be stored in a multi-function image forming apparatus.

FIG. 5 is a block diagram of an embodiment a recorded workflow.

FIG. 6 is a flow chart of an embodiment of recording a workflow on a multi-function image forming apparatus.

FIG. 7 is a flow chart of an embodiment of using a recorded workflow on a multi-function image forming apparatus.

### DETAILED DESCRIPTION

For purposes of this disclosure, a multi-function image forming apparatus (MFA) may include any instrumentality or aggregate of instrumentalities operable to perform operations on data of a document such as, for example, print, send a facsimile (“fax”), scan, copy data from an origination document (e.g., electronic file, tangible document) to a second location. The second location may include another document (e.g., physical document/paper) within the MFA, a remote server including for example, an email server, another MFA, a fax machine, and/or other suitable locations. A typical MFA includes a multi-function printer (or MFP). A document may be in tangible or electronic form.

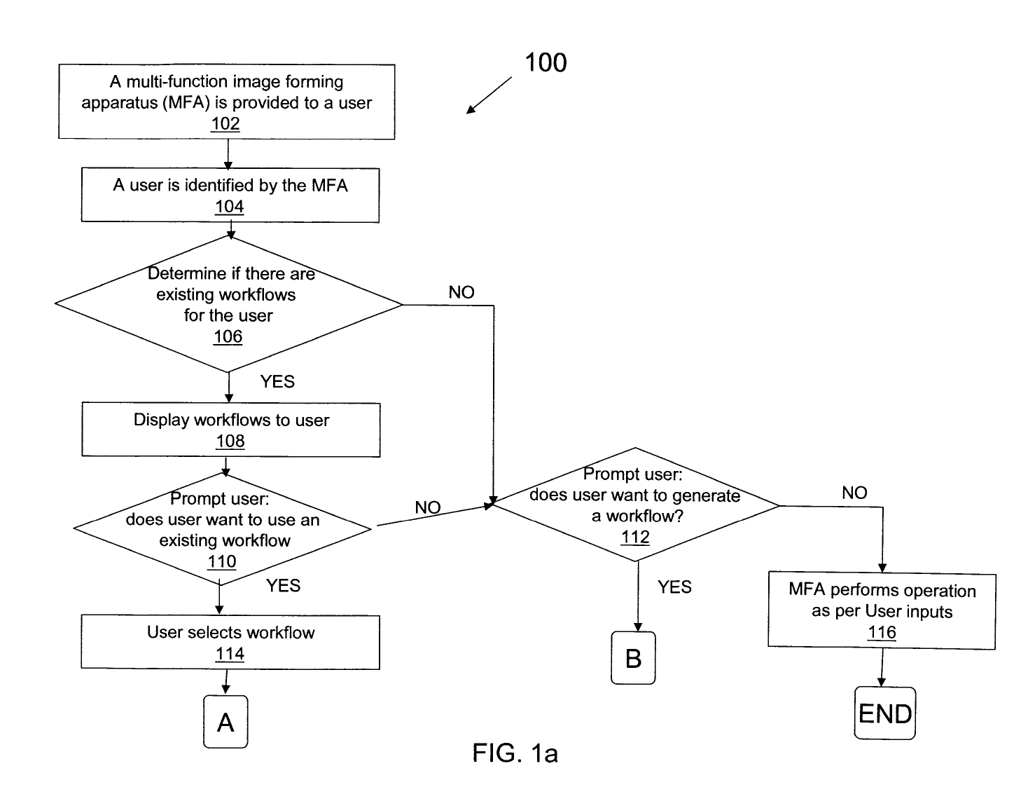

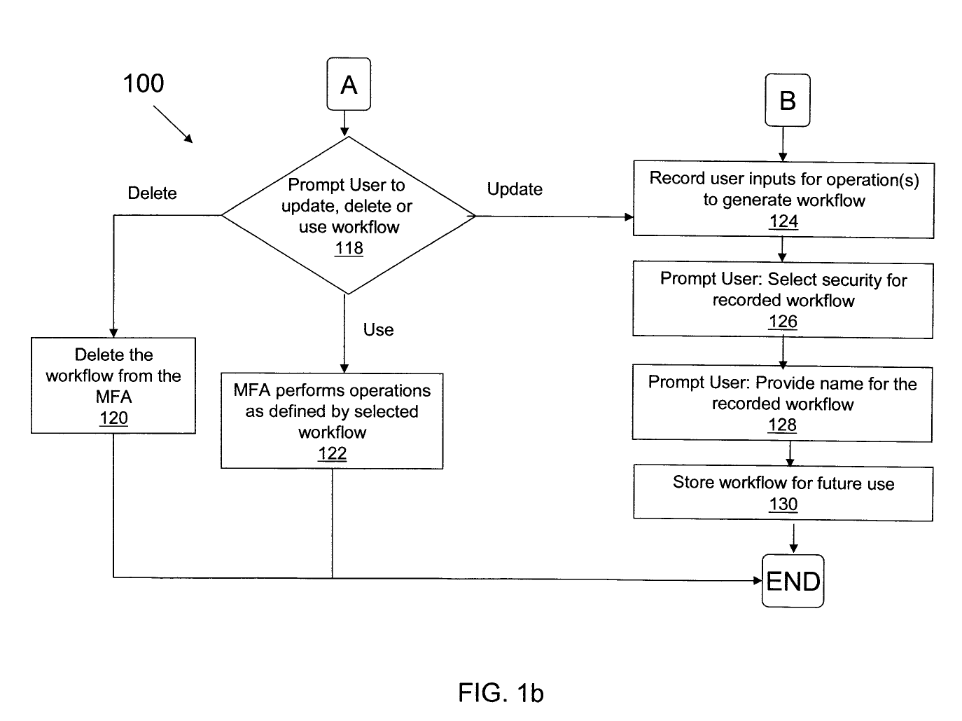

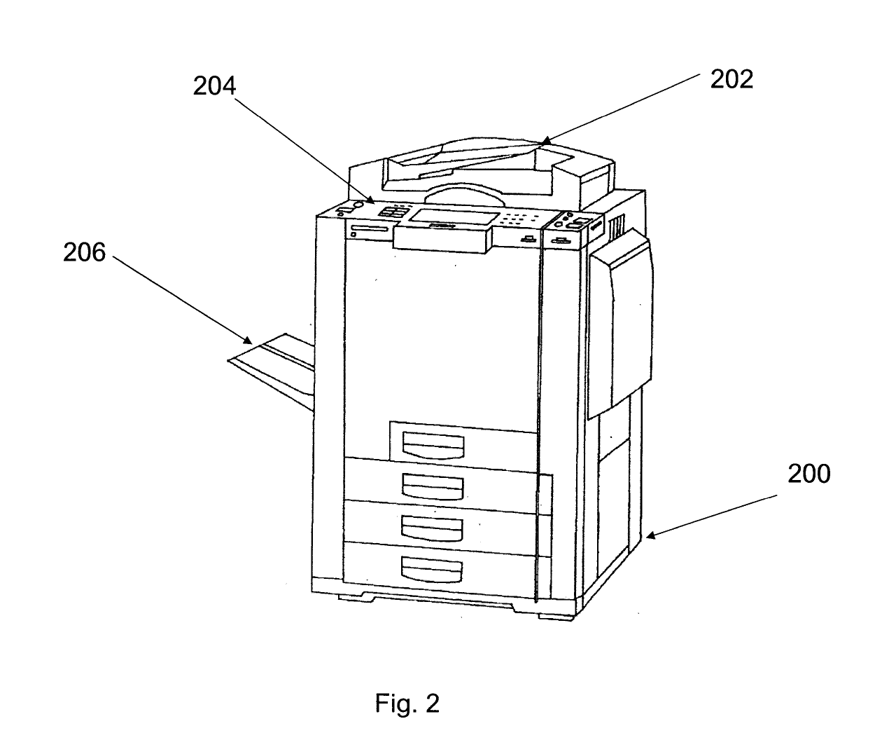

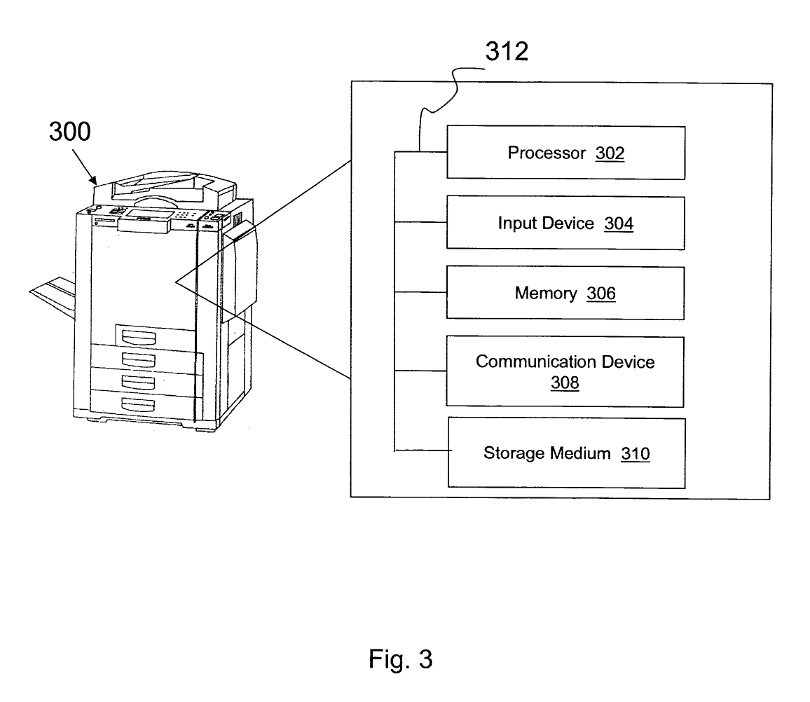

Referring now to FIG. 1, illustrated is a method 100 for controlling and/or operating a MFA according to one or more aspects of the present disclosure. The method 100 begins at block 102 where a multi-function image forming apparatus (MFA) is provided to a user. In an embodiment, the MFA is a multi-function printer. The MFA may be substantially similar to as described below with reference to FIGS. 2 and 3. The MFA may be an apparatus having, in a single housing, at least two of the following functionalities: scanning, printing, copying and/or faxing data from an origination document. The user may utilize the MFA for commercial or personal (e.g., entertainment) purposes.

The method 100 then continues to block 104 where the user is identified by the MFA. In an embodiment, the user is identified by an access card (e.g., RF ID card) such as used in the context of an employment location. In embodiments, block 104 is omitted from the method 100.

The method 100 then continues to block 106 where the MFA determines if there are existing workflows associated with the user. In an embodiment, the MFA includes security settings such that a workflow may be associated with a specific user and/or sub-set of users. In an embodiment, the MFA designates workflows as public (e.g., available for all users) and private (e.g., available to a subset of users). The workflows are described in further detail below. The workflows identified include workflows recorded by users of the MFA (i.e., recorded workflows). The recorded workflows are distinct from those operations pre-loaded by a manufacturer of the MFA in that one or more preferences of the workflows are specifically determined by a user and “recorded” during a use of the MFA, as described with reference to block 124 below. If there are no workflows associated with the user, the method 100 proceeds to block 112, described in further reference below.

If there are workflows associated with the user, the method 100 then continues to block 108 where the MFA displays a listing of the workflows (e.g., titles) to the user. The MFA may display the workflows on a user input device such as described below with reference to FIG. 2. The displayed workflows may include public and/or private recorded workflows.

The method 100 then continues to block 110 where the MFA prompts the user to select whether he would like to use an existing workflow (i.e., a previously recorded workflow). The prompt may be communicated via a user input device such as described below with reference to FIG. 2. If the user chooses to use an existing workflow, the method 100 continues to block 114 where the user selects the desired workflow. In an embodiment, the user selects the workflow using a user input device such as described below with reference to FIG. 2. If the user chooses not to use an existing workflow, the method 100 continues to block 112, which is described in further detail below.

After selecting the desired workflow (e.g., previously recorded workflow) at block 114, the method 100 then proceeds to block 118 where the MFA prompts the user to determine whether the user would like to update, delete, or use the workflow selected at block 114. If the user selects to delete the workflow, the method 100 then proceeds to block 120 where the workflow is deleted from the MFA. In an embodiment, the workflow is removed from the memory of the MFA such as described below with reference to FIG. 3. The method 100 then ends. In an embodiment, the method 100 then returns to block 108, described above.

If the user selects to use the workflow in block 118, the method 100 then proceeds to block 122 where the workflow is implemented and performed by the MFA. In other words, the previously recorded workflow is played back. The workflow may include a plurality of operations such as, for example, faxing, copying, scanning, printing, and/or other suitable operations. The plurality of operations may be performed by the MFA simultaneously (from the perspective of the user). In other words, the user may input the origination document into the MFA (and/or the document may be input to the MFA by another user/system or be stored on the MFA itself) and the selected workflow is then used by the MFA to perform a plurality of operations on the origination document and then outputs the origination document onto an output tray. The MFA includes a document input system that may include a feeder tray, means for receiving a storage medium (e.g., thumbdrive), a communication link with a second location (e.g., server). Thus, the user is not required to input the origination document more than once for the workflow, even though two or more operations are performed.

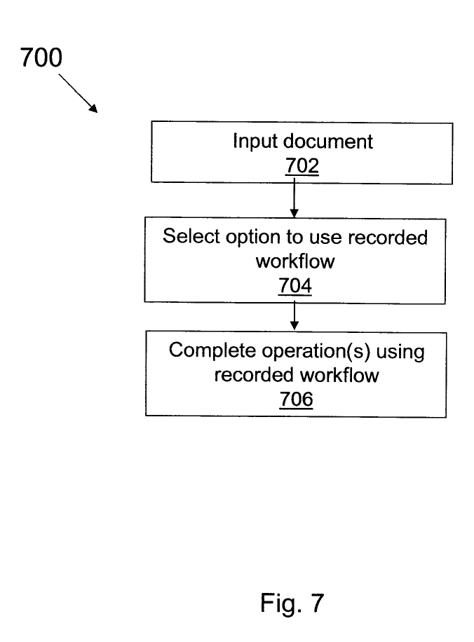

The workflow also includes settings or preferences for one or more operations that were previously determined by a user, recorded by the MFA, and stored by the MFA, according to one or more of the aspects of this disclosure. The settings or preferences may include, for example, for a copy operation: a number of copies to be made, a contrast for the data to be reproduced, a quality metric for the data to be reproduced, a sizing (e.g., zoom) of the data to be reproduced, a size of paper, a tray of the MFA to be used, a preparation manner (e.g., stapled, collated, double-sided, etc), and/or other known preferences to be set during a copy operation. The settings or preferences may include, for example, for a scan operation: a number of documents or files to be made, a resolution for the scan, a sizing (e.g., zoom), a document type, a destination for the scanned data (e.g., an email address, a server location, a folder location, etc), and/or other known preferences to be set during a scan operation. The settings or preferences may include, for example, for a fax operation: a number of documents to be faxed, a quality of the data to be faxed, a sizing (e.g., zoom) of the data to be faxed, a size of paper, a destination for the fax operation (e.g., phone number), and/or other known preferences to be set during a fax operation. The settings or preferences may include, for example, for a print operation: a number of documents to be made, a contrast for the data to be reproduced, a quality metric for the data to be reproduced, a sizing (e.g., zoom) of the data to be reproduced, a size of paper, a tray of the MFA to be used, a preparation manner (e.g., stapled, collated, double-sided, etc), and/or other known preferences to be set during a print operation. An example of a workflow performed by a MFA is illustrated below with reference to FIG. 7. The workflow may be performed (or played back) without a connection to a peripheral device (e.g., personal computer). After the recorded workflow is performed by the MFA in block 122, the method 100 may proceed to end, or return to block 108 where a user may chose to perform another operation.

Returning now to block 112 of the method 100, the MFA prompts the user to decide whether the user would like to generate (e.g., record) a workflow. If the user decides not to record a workflow, the method 100 proceeds to block 116 where the MFA performs the operation as per the user's inputs (e.g., at the time of the operation). This may be the standard operation of a MFP known in the art. In a typical operation, this operation requires the user to input several parameters or preferences for the operation that is to be performed. If the user desires to perform multiple operations (e.g., copy and scan and email the document), it is typical for the user to be required to perform the operations serially in the MFA with input preferences (e.g., menu selections) required for each operation and/or for the user to be required to re-input the origination documents (e.g., replace the documents onto the feeder).

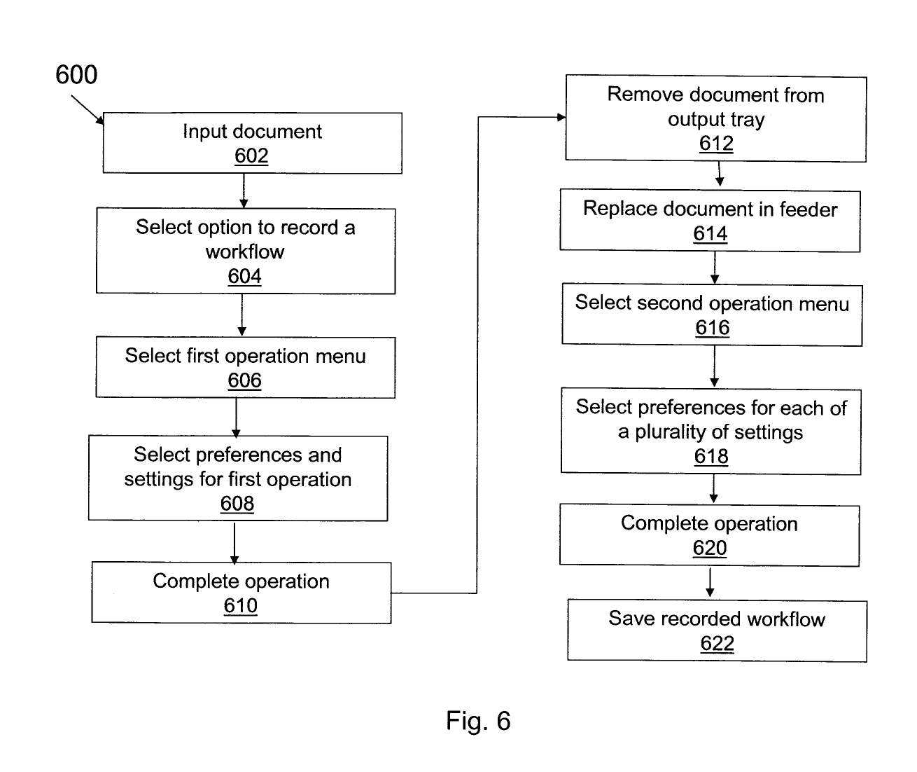

If the user decides to generate (e.g., record) a workflow at block 112, the method 100 then proceeds to block 124. At block 124, the user performs the operations much as described above with reference to block 116. For example, the user may load feeder tray of the MFA with original documents. In other embodiments, the user may load the origination document into the MFA using a USB thumbdrive, the document may be present on the MFA (e.g., harddrive), the user may select to input the document from a shared location (e.g., a server), and/or other suitable means for inputting a document (including electronic or tangible (e.g., paper, photo) documents). The user may then, using the user input device of the MFA, determine which operation to perform and associated settings and preferences associated with the selected operation. In an embodiment, multiple operations may be performed (e.g., a copy operation and a scan operation). The operation, settings and preferences may be selected by the user from a menu of options. An example of generating or recording a workflow is illustrated below with reference to FIG. 6.

At block 124, the MFA “records” or stores each of the users selected operations and selected settings or preferences of that operation. These selected operations and settings or preferences may be stored by the MFA (e.g., in the memory of the MFA). The settings or preferences recorded may include, for example, for a copy operation: a number of copies to be made, a contrast for the data to be reproduced, a quality metric for the data to be reproduced, a sizing (e.g., zoom) of the data to be reproduced, a size of paper, a tray of the MFA to be used, a preparation manner (e.g., stapled, collated, double-sided, etc), and/or other known preferences to be set during a copy operation. The settings or preferences recorded may include, for example, for a scan operation: a number of documents or files to be made, a resolution for the scan, a sizing (e.g., zoom), a document type, a destination for the scanned data (e.g., an email address, a server location, a folder location, etc) and/or other known preferences to be set during a scan operation. The settings or preferences recorded may include, for example, for a fax operation: a number of documents to be faxed, a quality of the data to be faxed, a sizing (e.g., zoom) of the data to be faxed, a size of paper, a destination for the fax operation (e.g., phone number), and/or other known preferences to be set during a fax operation. The settings or preferences may include, for example, for a print operation: a number of documents to be made, a contrast for the data to be reproduced, a quality metric for the data to be reproduced, a sizing (e.g., zoom) of the data to be reproduced, a size of paper, a tray of the MFA to be used, a preparation manner (e.g., stapled, collated, double-sided, etc), and/or other known preferences to be set during a print operation. The workflow recorded also includes which operations were performed. In an embodiment, the workflow records the chronological order of the operations.

The method 100 then proceeds to block 126 where the MFA prompts the user to select a security for the workflow recorded at block 124. For example, the user may elect to make the workflow public or private (e.g., available to a subset of users). In an embodiment, the user elects to make the workflow available only to the specific user as identified by an access card, such as discussed above with reference to block 104 of the method 100. In an embodiment, block 126 is omitted.

The method 100 then proceeds to block 128 where the MFA prompts the user to title the workflow recorded at block 124. In an embodiment, the MFA entitles the recorded workflow. In an embodiment, block 128 is omitted. The method 100 then proceeds to block 130 where the MFA stores the recorded for future use. The MFA may store the recorded workflow in the memory and/or storage medium described below with reference to FIG. 3. The method then proceeds to END, or may return to block 108 for the user to perform additional operations.

Thus, described is a method of operating and controlling a MFA, which allows for recording of workflows and utilizing the recorded workflows. This may allow a user of an MFA to customize a workflow for a repetitive task, which can improve the efficiency of a user. The recorded workflows can include any plurality of operations offered by an MFA and may include a number of settings or preferences associated with the selected operations, as defined by the user.

Referring now to FIG. 2, illustrated is a MFA 200. The MFA 200 may perform the functions described above with reference to FIG. 1. The MFA 200 includes a document feeder tray 202, a user input device 204, and an output tray 206. The document feeder tray 202 may be one component of an document input system operable receive documents (e.g., electronic or tangible) into the MFA 200. The MFA 200 includes devices operable to scan, copy, print, and/or fax documents, for example, documents positioned in the feeder tray 202. In an embodiment, the feeder tray 202 is an automatic data feeder. The user input device 204 may include a keyboard, a touchscreen, a display (e.g., an LCD display), pointing device, and/or a variety of other input devices known in the art. The MFA 200 as depicted has a single housing. The MFA 200 input document system may also be operable to receive electronic documents from external storage medium (e.g., a thumbdrive), remote server locations, memory and/or storage medium within the MFA 200 (e.g., harddrive), etc.

Referring now to FIG. 3, illustrated is an MFA 300. The MFA 300 may be substantially similar to the MFA 200 and may be used to perform one or more of the blocks of the method 100, described above with reference to FIG. 1. The MFA 300 includes a processor 302 (such as a central processing unit (CPU)), an input device 304, a memory 306, a communication device 308, and a storage medium 310. One or more of these devices may be referred to as a recordable workflow unit, a system of hardware and/or software, which provides for recording, storing, and/or implementing workflows, such as described above with reference to FIG. 1. The communication device 308 may include communications ports for communicating with external devices via an internet (e.g., LAN or WLAN connection). The MFA 300 also includes one or more buses 312 operable to transmit communications between the various hardware components.

Examples of input device 304 may include circuitry associated with or connected to a user input device such as keypads, touchscreens, pointing devices, and/or a variety of other input devices known in the art. The input device 304 may include functionality to recognize an access card through, for example, a radio frequency. Programs and data may be stored on the storage device 310, which is coupled to processor 302. Examples of storage devices may include hard discs, optical disks, CD-ROM, magneto-optical discs, solid-state storage devices, and/or a variety other mass storage devices known in the art. The storage device 310 may be non-transitory. In addition, the storage device 310 may be capable of receiving a floppy disk, CD-ROM, DVD-ROM, or any other form of computer-readable medium that may contain computer-executable instructions. The system memory 306 is coupled to processor 302 to provide the processor with fast storage to facilitate execution of computer programs by processor 302. Examples of system memory may include random access memory (RAM) devices such as dynamic RAM (DRAM), synchronous DRAM (SDRAM), solid state memory devices, and/or a variety of other memory devices known in the art. The system memory 302 may include flash memory where the data obtained from a document is stored. The system memory 302 may also include non-volatile RAM, which may be used to store recorded workflows, such as described above with reference to the method 100. In an embodiment, the storage device 310 includes the instructions to generate and/or store the recorded workflows. The processor 302 may perform at least two of the following operations: scan operations, print operations, copy operations, and fax operations.

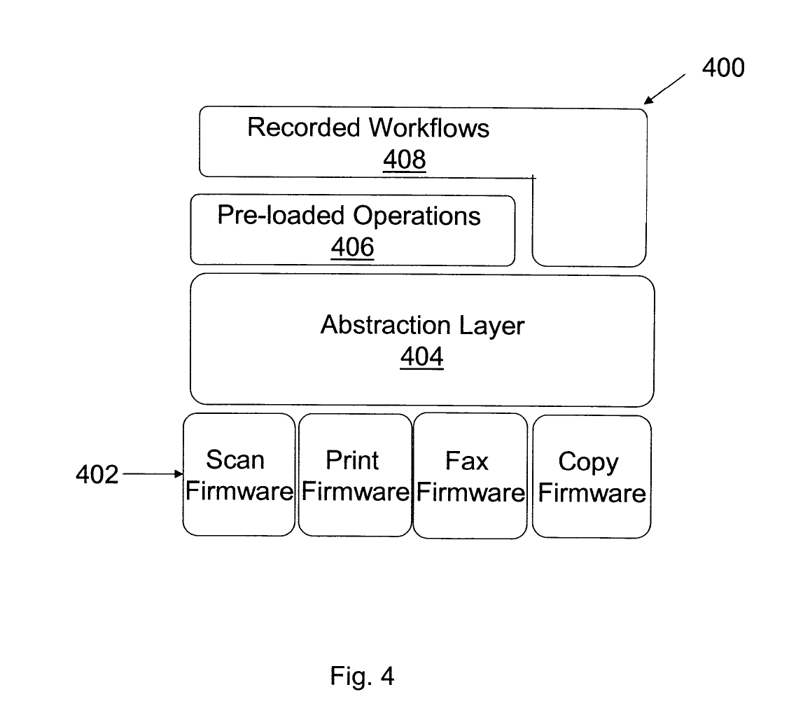

Referring now to FIG. 4, illustrated is a block diagram of an embodiment of a software stack 400 that is included in MFA such as the MFA 200 and/or the MFA 300, described above with reference to FIGS. 2 and 3, respectively. The stack 400 includes a first layer of firmware 402 which includes scan firmware, print firmware, fax firmware, and copy firmware. The firmware layer 402 may manage various operations of the MFA 200 such as, scanning, printing, faxing, copying, and/or other suitable operations. In other embodiments, one or more of the operations for which firmware is provided in the stack 400 are omitted. An abstraction layer 404 is provided on the firmware layer 402. A pre-loaded operations layer 406 is provided on the abstraction layer 404. The pre-loaded operations layer 406 may include selected operations with determined settings or preferences pre-set and loaded by the manufacturer of the MFA. A recorded workflow layer 408 is provided on the abstraction layer 404. The abstraction layer of application program interface (API) layer may allow the pre-loaded operations layer 406 and/or the recorded workflow layer 408 to communicate with the firmware layer 402.

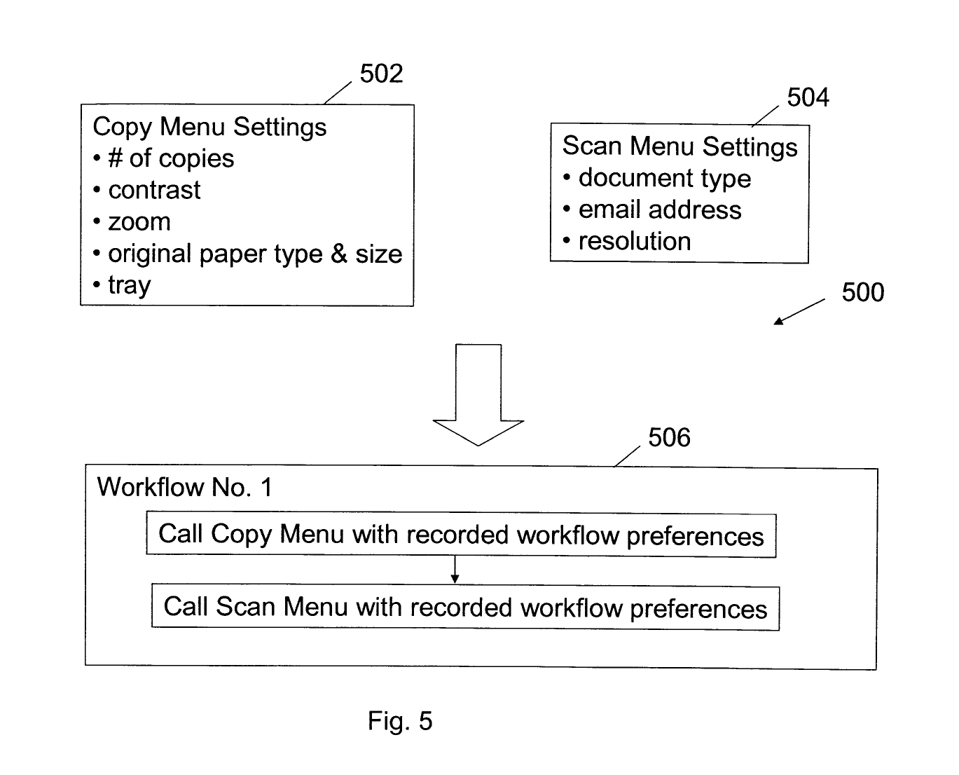

In an embodiment, the recorded workflow layer 408 includes recorded workflows that include functional calls to the basic modules (e.g., included in the firmware 402). Such a recorded workflow is described below with reference to FIG. 5. In an embodiment, the recorded workflows duplicate and combine existing modules into new workflows. Though this may include advantages such as speed, it may be memory intensive as the modules are duplicated.

Referring now to FIG. 5, illustrated is a block diagram of a system 500 which includes copy operation firmware 502 and scan operation firmware 504, which are depicted as a menu which may be presented to a user. Also illustrated is a workflow 506. The workflow 506 includes functional calls to the copy operation firmware 502 and scan operation firmware 504. The copy operation firmware 502 and scan operation firmware 504 are provided by the MFA manufacturer. Thus, the workflow 506 may be a macro (e.g., a single instruction that results in a series of instructions in machine language). The workflow 506 may be created, generated, and/or utilized as described above with reference to the method 100 of FIG. 1.

Referring now to FIG. 6, illustrated is a flow chart of an embodiment of a method 600 of recording a workflow. The method 600 may be substantially similar to block 124 of the method 100, described above with reference to FIG. 1. The method 600 begins at block 602 where a document is placed in a feeder of a MFA. The feeder may be substantially similar to the feeder 202 of the MFA 200, described above with reference to FIG. 2. In an embodiment, the feeder is an automatic document feeder.

The method 600 then proceeds to block 604 where an option to record a workflow is selected on the MFA. Block 604 may be substantially similar to block 110 of the method 100, described above with reference to FIG. 1. The option may be selected on a user interface device of an MFA, such as the user device 204 of the MFA 200, described above with reference to FIG. 2. In an embodiment, an option to record a workflow is selected from a touchscreen.

The method 600 then proceeds to block 606 where a first operation menu is selected. In an embodiment, the first operation is a copy operation. Other exemplary operations include a scan operation, a fax operation, a printer operation, and/or other suitable operations typical of an MFA. The operation may be selected by a user via a user input device such as the input device 204 of the MFA 200, described above with reference to FIG. 2.

The method 600 then proceeds to block 608 where a user may select one or more preferences or settings for the selected operation. In an embodiment, the operation selected in block 606 is a copy operation and the settings or preferences may include, for example, a number of copies to be made, a contrast for the data to be reproduced, a quality metric for the data to be reproduced, a sizing (e.g., zoom) of the data to be reproduced, a size of paper, a tray of the MFA to be used, a preparation manner (e.g., stapled, collated, double-sided, etc), and/or other known preferences to be set during a copy operation. Other exemplary settings or preferences include, for example, for a scan operation: a number of documents or files to be made, a resolution for the scan, a sizing (e.g., zoom), a document type, a destination for the scanned data (e.g., an email address, a server location, a folder location, etc) and/or other known preferences to be set during a scan operation. As further example, for a fax operation, preferences or settings include: a number of documents to be faxed, a quality of the data to be faxed, a sizing (e.g., zoom) of the data to be faxed, a size of paper, a destination for the fax operation (e.g., phone number), and/or other known preferences to be set during a fax operation. The settings or preferences may also include, for example, for a print operation: a number of documents to be made, a contrast for the data to be reproduced, a quality metric for the data to be reproduced, a sizing (e.g., zoom) of the data to be reproduced, a size of paper, a tray of the MFA to be used, a preparation manner (e.g., stapled, collated, double-sided, etc), and/or other known preferences to be set during a print operation. The settings or preferences may be selected using a menu displayed on a user input device (e.g., a touchscreen).

The selection by the user of the operation and settings or preferences for the operation are “recorded” by the MFA. In an embodiment, the MFA collects the relevant information and stores the selections in a memory device, such as the memory device described above with reference to FIG. 3.

The method 600 then proceeds to block 610 where the MFA completes the operation. For example, in an embodiment, the MFA completes a copy operation using the user's defined settings and preferences, and makes one or more copies of a document input to the MFA, as described above with reference to block 602. The method 600 then proceeds to block 612 where the document (e.g., original document) is removed from the output tray of the MFA. The output tray may be substantially similar to the output tray 206, described above with reference to FIG. 2. In other embodiments, the operation performed produces an electronic document which is delivered to a second location (e.g., server, email) within or outside the MFA.

The method 600 then proceeds to block 614 where the document (e.g., original document) is again input to the MFA. In an embodiment, the document is again placed in the feeder of the MFA. The feeder may be substantially similar to the feeder 202 of the MFA 200, described above with reference to FIG. 2. In an embodiment, the feeder is an automatic document feeder. The feeder may be the same feeder as described above with reference to block 602.

The method 600 then proceeds to block 616 where a second operation menu is selected. In an embodiment, the second operation is a scan operation. Other exemplary operations include a copy operation, a fax operation, a printer operation, and/or other suitable operations typical of an MFA. The scan operation may include communicating the scanned data to a second location, outside of the MFA. In an embodiment, the scan operation includes emailing the document to one or more email addresses or servers. Other exemplary locations include servers, thumb-drives, and/or other suitable locations. The operation may be selected by a user via a user input device such as the input device 204 of the MFA 200, described above with reference to FIG. 2.

The method 600 then proceeds to block 618 where a user may select one or more preferences or settings for the selected second operation. In an embodiment, the operation selected in block 616 is a scan operation and the settings or preferences may include: a number of documents or files to be made, a resolution for the scan, a sizing (e.g., zoom), a document type, a destination for the scanned data (e.g., an email address, a server location, a folder location, etc), and/or other known preferences to be set during a scan operation. Other exemplary settings or preferences include, for example, for a copy operation, a number of copies to be made, a contrast for the data to be reproduced, a quality metric for the data to be reproduced, a sizing (e.g., zoom) of the data to be reproduced, a size of paper, a tray of the MFA to be used, a preparation manner (e.g., stapled, collated, double-sided, etc), and/or other known preferences to be set during a copy operation for example, and, as further example, for a fax operation a number of documents to be faxed, a quality of the data to be faxed, a sizing (e.g., zoom) of the data to be faxed, a size of paper, a destination for the fax operation (e.g., phone number), and/or other known preferences to be set during a fax operation. The settings or preferences may include, for example, for a print operation: a number of documents to be made, a contrast for the data to be reproduced, a quality metric for the data to be reproduced, a sizing (e.g., zoom) of the data to be reproduced, a size of paper, a tray of the MFA to be used, a preparation manner (e.g., stapled, collated, double-sided, etc), and/or other known preferences to be set during a print operation. The settings or preferences may be selected using a menu displayed on a user input device (e.g., a touchscreen).

The selection by the user of the operation and settings or preferences for the operation of blocks 616 and 618 are “recorded” by the MFA. In an embodiment, the MFA collects the relevant information and stores the selections in a memory device, such as the memory device described above with reference to FIG. 3. The information collected may include the settings and/or preferences including, for example, one or more email addresses and/or server locations to which the scanned data is to be communicated.

The method 600 then proceeds to block 620 where the MFA completes the second operation. For example, in an embodiment, the MFA completes a scan operation including reading the data from the original document and communicating the data to one or more locations.

The method 600 then proceeds to block 622 where the workflow (e.g., information or selections of blocks 604, 608, 616, and 618) are saved or stored by the MFA. The MFA may save the information in a memory device and/or storage device such as described above with reference to FIG. 3. The saving the workflow may be substantially similar to block 130 of the method 100, as described above with reference to FIG. 1. The recorded workflow may include one or more calls to the functional code of the MFA (e.g., operation firmware). An example of such a workflow is described above with reference to FIG. 5. Though depicted herein as including two operations in a workflow, the method 600 may be used to provide a workflow having any number of operations.

Referring now to FIG. 7, illustrated is a method 700 of using a recorded workflow. The method 700 may use a workflow generated (recorded) by the method 600, described above with reference to FIG. 6. The method 700 begins at block 702 where a document is input into the MFA. In one embodiment, a tangible document placed in a feeder of an MFA. The feeder may be substantially similar to the feeder 202 of the MFA 200, described above with reference to FIG. 2. Tangible documents may include any form of data such as, text, pictures, graphical representations, and/or other suitable data. In other embodiments, the document is an electronic document and input to the MFA via external storage medium, communication with a second location (e.g., server) and/or other suitable methods. In one embodiment, the document is stored within the MFA.

The method 700 then proceeds to block 704 where a user selects an option of using a recorded workflow and finally, to block 706 where the selected workflow is completed. The MFA recalls the selected recorded workflow from its memory and/or storage and performs the operation(s) of the recorded workflow. The workflow may include functional calls to the MFA firmware, such as illustrated in the workflow 506, described above with reference to FIG. 5. The workflow may include any number of operations. As but one example, the workflow may include two operations such as described above with reference to the method 600 illustrated in FIG. 6. One or more operations may be performed without the user selecting the specific operation (e.g., scan, copy, print, fax) from a menu on the MFA. One or more settings or preferences for the operations may be selected and utilized without the user selecting the specific setting or preference for the operation. In an embodiment, two or more operations are performed without the user making a selection on a user input device of the MFA. In an embodiment, two or more operations are performed with the user having placed the origination document on a feeder tray a single time.

Thus, embodiments of the present disclosure may provide advantages to a user of a MFA. Embodiments allow a standalone MFA, without a connection to a personal computer, to provide for a user to define and record its own workflow. The workflow may be a set of operations which are routinely performed by the user, and thus, the recorded workflow may result in minimized effort and time to perform these tasks. Once the workflows have been recorded, the user may re-use the workflow for example, with a single touch on a user input device of the MFA. One or more embodiments allow various security features for the recorded workflows, which may be beneficial to some enterprises. It is noted that it would be infeasible for a provided of the MFA to provide all possible workflows that a user may desire, thus, the present disclosure provides embodiments that allow for improved user customization and experience.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A method, comprising:
receiving a selection of a first operation, wherein the first operation is at least one of a printing, a faxing, a scanning, and a copying operation performed by a multi-function image forming apparatus;
receiving a selection of a first preference associated with the first operation;
generating a workflow including the first operation and the first preference;
storing the generated workflow in the multi-function image forming apparatus; and
using the stored workflow to perform the first operation having the first preference on a document on an input feeder of the multi-function image forming apparatus.

2. The method of claim 1, further comprising:
receiving a selection of a second operation different than the first operation, wherein the second operation is at least one of printing, faxing, scanning, and copying a document;
receiving a selection of a second preference associated with the second operation;
and wherein the workflow further includes the second operation and the second preference, and wherein using the stored workflow includes performing the second operation on the document.

3. The method of claim 2, wherein the first operation is a copy operation and the second operation is a scan operation.

4. The method of claim 1, wherein the first operation is a copy operation and the first preference is selected from the group consisting of: a number of copies to be made, a contrast, a quality metric, a sizing, a size of paper, a tray location, and a preparation manner.

5. The method of claim 1, wherein the first operation is a scan operation and the first preference is selected from the group consisting of: a number scans to be performed, a resolution, a sizing, a document type, a destination server location, and a destination email address.

6. The method of claim 1, wherein the using the workflow includes making functional calls to firmware of the multi-function image forming apparatus.

7. The method of claim 1, further comprising:
displaying to a user a menu of options including performing the workflow.

8. The method of claim 1, wherein the receiving the selection of the first operation includes receiving information from a user input device of the multi-function image forming apparatus.

9. The method of claim 1, further comprising:
prompting a user to provide a name for the workflow on a user input device the multi-function image forming apparatus.

10. The method of claim 1, further comprising:
determining the identity of a user;
determining the workflow is associated with the user; and
displaying the workflow to the user.

11. The method of claim 10, wherein the determining the identity of the user includes reading an identification card having a radio frequency (RF ID).

12. The method of claim 1, wherein the storing the workflow includes storing the workflow until a user selects to delete the workflow.

13. An apparatus comprising a computer-readable medium encoded with a computer program that, when executed:
records a selection of an operation of a user, the operation being one of printing, copying, faxing, and scanning a document;
records a selection by the user of a preference for the operation; and
stores the recorded selection and the recorded preference as a workflow.

14. The apparatus of claim 13, wherein the stored workflow includes instructions to perform a functional call to firmware associated with the operation.

15. The apparatus of claim 13, further comprising instructions that when executed:
assigns a security setting for the stored workflow.

16. The apparatus of claim 13, wherein the preference is selected from the group consisting of: a number of copies, a contrast, a quality metric, a sizing, a size of paper, a tray selection, and a preparation manner.

17. The apparatus of claim 13, further comprising instructions that when executed:
communicates the stored workflow to a processor of a multi-function image forming apparatus at a subsequent point in time.

18. A multi-function image forming apparatus, comprising:
a document input system configured to receive a document;
a processor, wherein the processor performs at least two operations on the received document, wherein the operations are selected from printing, scanning, faxing, and copying a document;
an input device operable to receive a selection of an operation and a preference for the operation from a user; and
recordable workflow unit for generating and storing a workflow, wherein the workflow stores the selected operation and preference.

19. The apparatus of claim 18, wherein the document input system includes a feeder tray.

20. The apparatus of claim 18, wherein the recordable workflow unit is operable to make functional calls to firmware of the multi-function image forming apparatus.
